(19) United States
(12) Patent Application Publication
(10) Pub. No.: US 2023/0155257 A1
(43) Pub. Date: May 18, 2023

(54) BATTERY ASSEMBLY, BATTERY MODULE, AND METHOD FOR MANUFACTURING THE SAME

(71) Applicants: Avary Holding (Shenzhen) Co., Limited., Shenzhen (CN); QING DING PRECISION ELECTRONICS (HUAIAN) CO.,LTD, Huai an (CN); GARUDA TECHNOLOGY CO., LTD., New Taipei (TW)

(72) Inventors: JIN-CHENG WU, Huai an (CN); HAO-WEN ZHONG, Shenzhen (CN); BIAO LI, Shenzhen (CN); MEI-HUA HUANG, Shenzhen (CN); NING HOU, Shenzhen (CN)

(21) Appl. No.: 18/097,836

(22) Filed: Jan. 17, 2023

Related U.S. Application Data
(63) Continuation-in-part of application No. PCT/CN21/01045, filed on Jun. 18, 2021.

(51) Int. Cl. H01M 50/519; H01M 50/505; H01M 10/653; H01M 50/583; H01M 10/04; H01M 10/613; H01M 10/6551

(52) U.S. Cl. CPC H01M 50/519; H01M 10/04; H01M 10/613; H01M 10/653; H01M 10/6551; H01M 50/505; H01M 50/583

(57) ABSTRACT

A battery assembly includes a circuit board and a battery cell. The circuit board includes a first dielectric layer, a second dielectric layer, an adhesive film, a bus bar, a first copper block, a fuse, and a second copper block. The adhesive film is located between the first dielectric layer and the second dielectric layer and includes cavities. The first copper block and the bus bar are on the first dielectric layer. The second copper block and the fuse are on the second dielectric layer. The circuit board is divided into heat dissipation areas and bending areas which are connected and alternately arranged, the heat dissipation areas and the bending areas enclose a holding groove. The bus bar and the first block copper are accommodated in the holding groove. The battery cell is accommodated in the holding groove. A battery module and a manufacturing method are also disclosed.

### FIELD

The subject matter herein generally relates to the field of heat dissipation of a battery, in particular, to a battery assembly, a battery module, and a method for manufacturing a battery assembly.

### BACKGROUND

A battery is an important power source for a piece of equipment, such as an electric vehicle. In order to meet demand for high power of the piece of equipment, a plurality of battery cells are usually assembled together to form a battery module. The battery module should have over-current protection and thermal management functions to ensure safety.

In known battery modules, currents of the battery cells are usually collected through bus bars, fuses are installed to achieve over-current protection, and additional cooling pipes are installed to cool the battery module. However, the bus bars, fuses, and cooling pipes are all independent components, which require additional space for accommodation. In addition, the cooling pipes are installed at both ends of the battery cells, which may not meet the heat dissipation requirements of the battery module when it is used at high power.

### BRIEF DESCRIPTION OF THE DRAWINGS

Implementations of the present technology will now be described, by way of embodiment, with reference to the attached figures.

FIG. 1 is a cross-sectional view of a single-sided copper clad laminate including a first dielectric layer and a first copper layer according to an embodiment of the present disclosure.

FIG. 2 is a cross-sectional view showing grooves exposing a surface of the first copper layer and formed by removing part of the first dielectric layer of FIG. 1.

FIG. 3 is a cross-sectional view showing a first thermally conductive adhesive infilled into the groove of FIG. 2.

FIG. 4 is a cross-sectional view showing a first thermally conductive sheet attached to the first thermally conductive adhesive of FIG. 3.

FIG. 5 is a cross-sectional view of a second substrate according to an embodiment of the present disclosure.

FIG. 6 is a cross-sectional view of an adhesive film according to an embodiment of the present disclosure.

FIG. 7 is a cross-sectional view showing a first substrate of FIG. 4, the adhesive film of FIG. 6, and the second substrate of FIG. 5 which are placed in sequence.

FIG. 8 is a cross-sectional view showing the first substrate, the adhesive film, and the second substrate of FIG. 7 which are pressed together.

FIG. 9 is a cross-sectional view of a circuit board.

FIG. 10 is a cross-sectional view showing a protective layer formed on the circuit board of FIG. 9.

FIG. 11 is a cross-sectional view showing a connecting sheet connected to a bus bar of the circuit board of FIG. 10.

FIG. 12 is a cross-sectional view showing a monitoring element connected to a fuse of the circuit board of FIG. 11.

FIG. 13 is a cross-sectional view showing adhesive layers bonded to a first copper block and a second copper block of the circuit board of FIG. 12.

FIG. 14 is a cross-sectional view of a battery assembly according to an embodiment of the present disclosure.

FIG. 15 is a cross-sectional view of a battery module formed by connecting two of the battery assemblies of FIG. 14.

FIG. 16 is a cross-sectional view of a battery module including a bracket according to an embodiment of the present disclosure.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure.

Several definitions that apply throughout this disclosure will now be presented.

The term “coupled” is defined as connected, whether directly or indirectly through intervening components, and is not necessarily limited to physical connections. The connection can be such that the objects are permanently connected or releasably connected. The term “substantially” is defined to be essentially conforming to the particular dimension, shape, or other feature that the term modifies, such that the component need not be exact. For example, “substantially cylindrical” means that the object resembles a cylinder, but can have one or more deviations from a true cylinder. The term “comprising,” when utilized, means “including, but not necessarily limited to”; it specifically indicates open-ended inclusion or membership in the so-described combination, group, series, and the like.

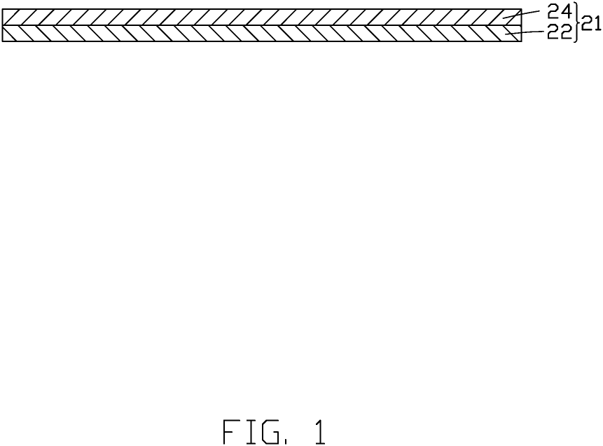

Referring to FIGS. 1 to 14, a method for manufacturing a battery assembly 100 is illustrate. The method includes steps as follows.

Step S1, referring to FIGS. 1 to 4, a first substrate 20 is provided. The first substrate 20 includes a first copper layer 24, a first dielectric layer 22, and a plurality of thermally conductive adhesive blocks 25. The first dielectric layer 22 is disposed on a surface of the first copper layer 24, and the thermally conductive adhesive blocks 26 penetrate the first dielectric layer 22 and are coupled to the first copper layer 24.

The first dielectric layer 22 is made of a flexible material, which is selected from a group consisting of polyimide, liquid crystal polymer, modified polyimide, and any combination thereof. In this embodiment, a material of the first dielectric layer 22 is polyimide.

In some embodiments, the first substrate 20 further includes a plurality of first thermally conductive sheets 26. The first thermally conductive sheets 26 is disposed on surfaces of the first thermally conductive adhesives 25 facing away from the first copper layer 24. The first thermally conductive adhesives 25 are spaced apart from each other, the first thermally conductive sheets 26 are also spaced apart from each other, which is convenient for bending in the subsequent manufacturing process.

The first thermally conductive sheets 26 are made of a material with good thermal conductivity, which includes, but is not limited to, metal or carbon materials. In this embodiment, a material of the first thermally conductive sheets 26 is copper.

In some embodiments, the first substrate 20 is formed by the following steps.

Step S101, referring to FIG. 1, a single-sided copper clad laminate 21 is provided. The single-sided copper clad laminate 21 includes the first dielectric layer 22 and the first copper layer 24 on a surface of the first dielectric layer 22.

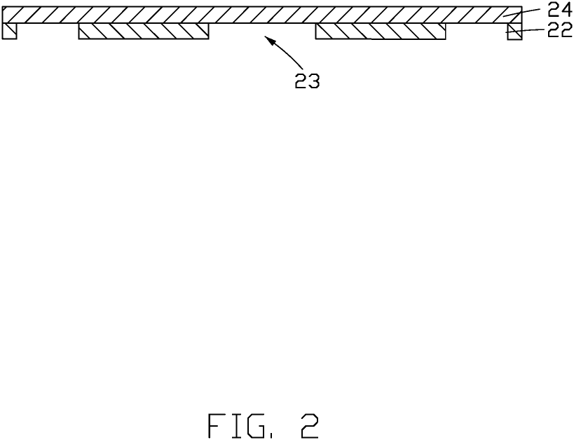

Step S102, referring to FIG. 2, parts of the first dielectric layer 22 are removed to form a plurality of grooves 23 which expose a surface of the first copper layer 24.

The grooves 23 penetrate the first dielectric layer 22 along a stacking direction of first copper layer 24 and the first dielectric layer 22. Positions of the grooves 23 are related to positions of cavities to be formed subsequently.

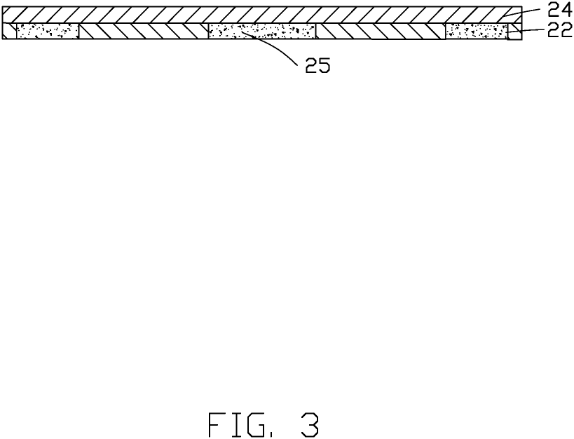

Step S103, referring to FIG. 3, the first thermally conductive adhesives 25 are infilled into the grooves 23.

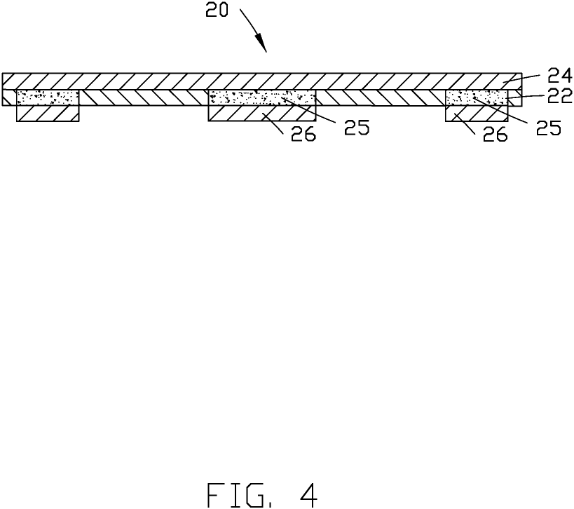

Step S104, referring to FIG. 4, the first thermally conductive sheets 26 are attached to surfaces of the first thermally conductive adhesives 25.

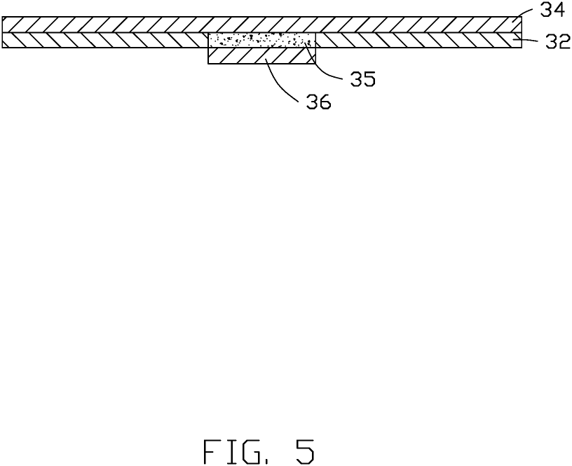

Step S2, referring to FIG. 5, a second substrate 30 is provided. The second substrate 30 includes a second copper layer 34, a second dielectric layer 32, and at least one second thermally conductive adhesive 35. The second dielectric layer 32 is on a surface of the second copper layer 34, and the second thermally conductive adhesive 35 penetrates the second dielectric layer 32 and is coupled to the second copper layer 34.

The second dielectric layer 32 is made of a flexible material.

Thicknesses of the first dielectric layer 22 and the second dielectric layer 32 are 1.25 µm to 25 µm, which is convenient for bending in the subsequent manufacturing process.

In some embodiments, the second substrate 30 further includes at least one second thermally conductive sheet 36. The second thermally conductive sheet 36 is on a surface of the second thermally conductive adhesive 35 facing away from the second copper layer 34. The second thermally conductive sheet 36 corresponds in position to at least one of the first thermally conductive sheet 26. A material of the second thermally conductive sheet 36 includes, but is not limited to, metal or carbon materials.

The second substrate 30 can be manufactured by steps

The steps of forming the second substrate 30 may be substantially the same as the steps of forming the first substrate 20. The second substrate 30 may also be formed by other methods.

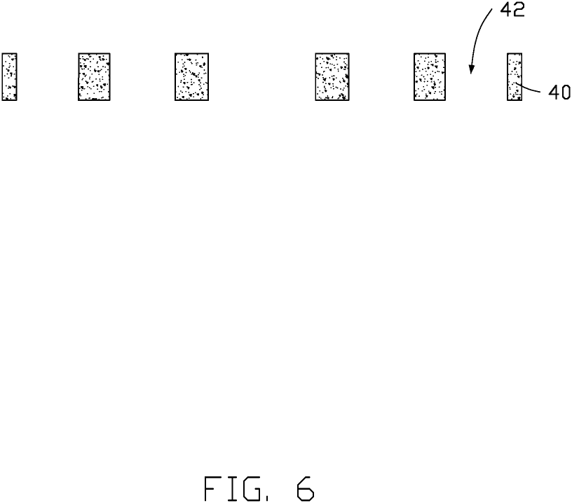

Step S3, referring to FIG. 6, an adhesive film 40 is provided. The adhesive film 40 includes a plurality of through holes 42. The through holes 42 corresponds in position to the first thermally conductive adhesives 25.

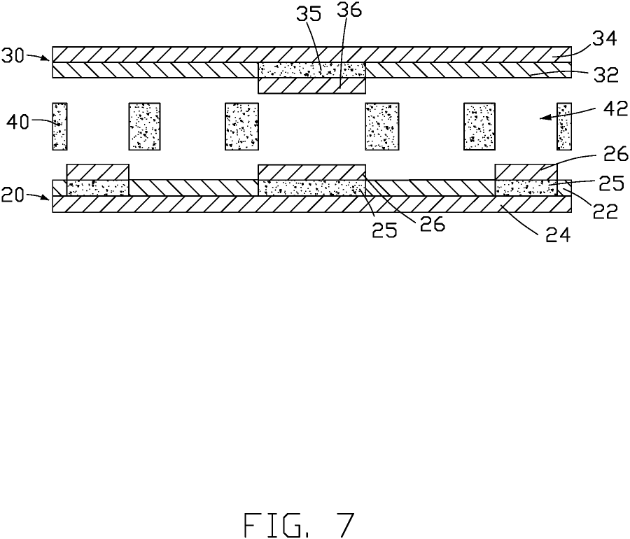

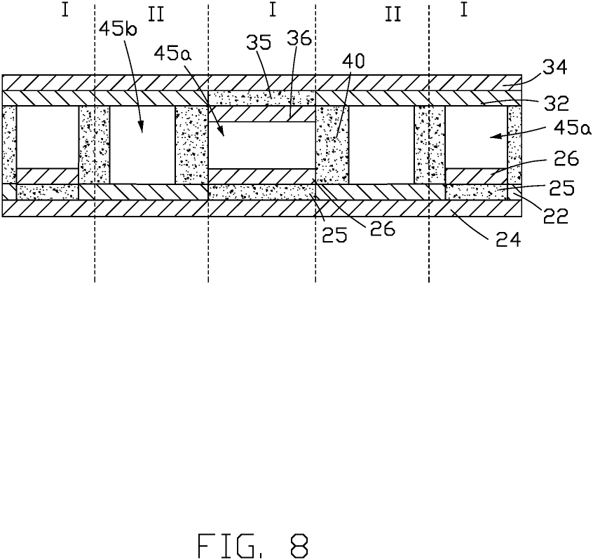

Step S4, referring to FIGS. 7 and 8, the first substrate 20 and the second substrate 30 are pressed onto opposite sides of the adhesive film 40 to seal the through holes 42 to form cavities 45a, thereby forming a plurality of heat dissipation areas I and a plurality of bending area II which are arranged at intervals in turn.

In a stacking direction of the first substrate 20, the adhesive film 40, and the second substrate 30, areas of the stacked structure including the first substrate 20, the adhesive film 40, and the second substrate 30 corresponding to the first thermally conductive adhesives 25 and/or the second thermally conductive adhesive 35 are the heat dissipation areas I, and one bending area II is located between two adjacent heat dissipation areas I.

In some embodiments, the first copper layer 24 is on a surface of the first dielectric layer 22 facing away from the adhesive film 40, the second copper layer 34 is on a surface of the second dielectric layer 32 facing away from the adhesive film 40, the first thermally conductive sheet 26 and the second thermally conductive sheet 36 are in the through holes 42.

In some embodiments, a number of the through holes 42 is greater than a number of the first thermally conductive sheet 26, so that a plurality of cavities 45a and 45b are formed, and each bending area II includes one cavity 45b. The cavities 45a and 45b are filled with air. Because the heat dissipation performance of air is better than that of the first dielectric layer 22 and the second dielectric layer 32, the arrangement of the cavities 45a and 45b can improve the heat dissipation performance. On the other hand, the arrangement of the cavities 45b is convenient for bending in the subsequent manufacturing process.

In some embodiments, the cavities 45a can also be filled with liquid, such as water, to further improve the heat dissipation efficiency.

In some embodiments, the number of cavities 45a or 45b located in one heat dissipation area I or one bending area II is not limited to one, but can also be multiple, and multiple cavities 45a or 45b are spaced through the adhesive film 40. A distance between two adjacent cavities 45a or 45b in one heat dissipation area I or one bending area II is greater than or equal to 1 mm. Since there will be glue overflow in the subsequent pressing process, a certain space for glue overflow is reserved.

A thickness of the adhesive film 40 is 100 µm to 300 µm, so that the first dielectric layer 22 and the second dielectric layer 32 will not be connected due to too close distance in the subsequent bending process.

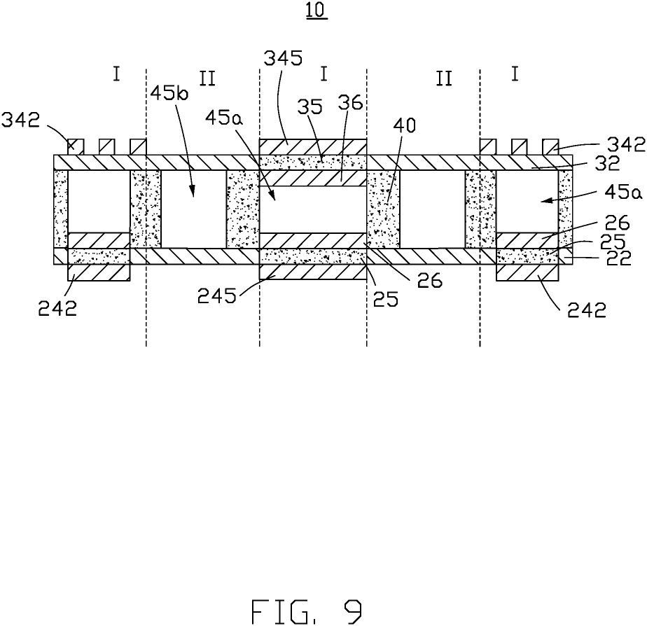

Step S5, referring to FIG. 9, the first copper layer 24 is etched to form bus bars 242 and a first copper block 245, and the second copper layer 34 is etched to form fuses 342 and a second copper block 345, thereby forming a circuit board 10.

The first copper layer 24 and the second copper layer 34 in the bending areas II are removed to facilitate the bending of the bending areas II in the subsequent process.

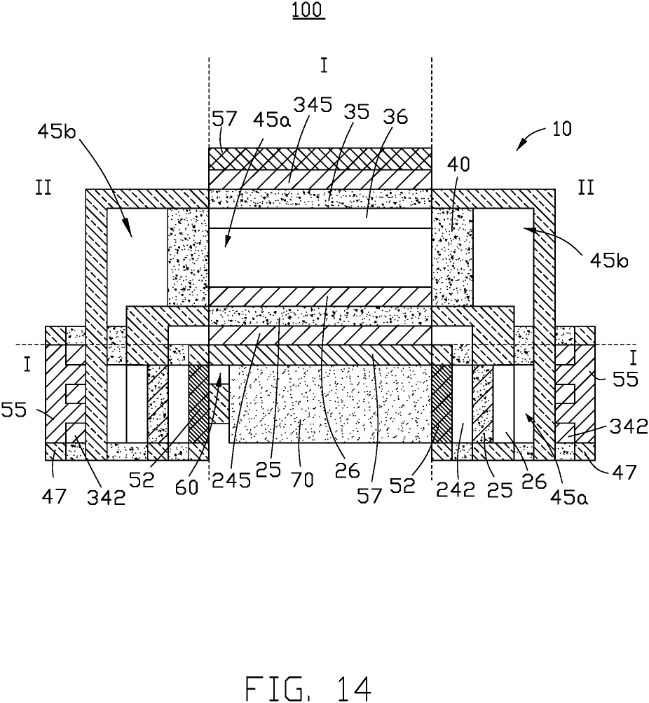

Portions of the first copper layer 24 and the second copper layer 34 in the heat dissipation areas I are removed by etching. The bus bars 242 are electrically coupled to a battery cell 70 (shown in FIG. 14). The fuses 342 are electrically coupled to the battery cell 70. When a certain threshold value is exceeded, the fuses 342 blocks the current in the battery cell 70 to protect the battery cell 70. The first copper block 245 and the second copper block 345 are in contact with the battery cell core 70, so that the heat generated by the battery cell 70 can be quickly transferred.

A thickness of the first copper layer 24 is greater than or equal to 35 µm, so that current after confluence can be in a preset range.

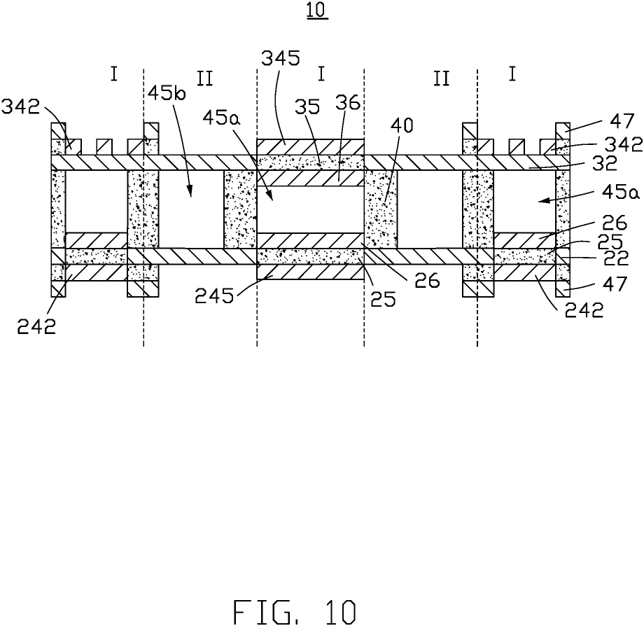

In some embodiments, referring to FIG. 10, the method further includes a step of forming protective layers 47. The protective layers 47 are located at the peripheries of the bus bars 242 and the fuses 342 to protect the bus bars 242 and the fuses 342.

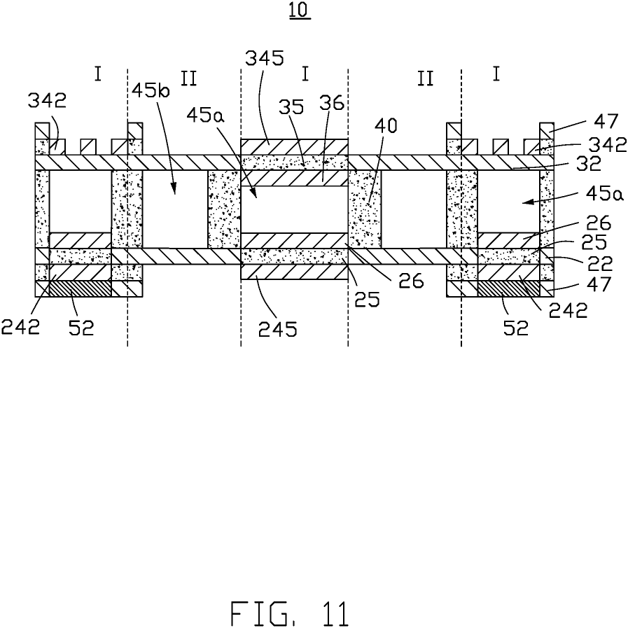

Step S6, referring to FIGS. 11 to 14, the bending areas II of the circuit board 10 are bent to form a holding groove 60, and the battery cell 70 is placed in the holding groove 60 and is electrically connected with the bus bars 242, thereby forming a battery assembly 100.

In some embodiments, step S6 includes the following steps.

Step S601, referring to FIG. 11, connecting sheets 52 are connected to surfaces of the bus bars 242.

The connecting sheets 52 are made of a conductive material, which includes but is not limited to nickel.

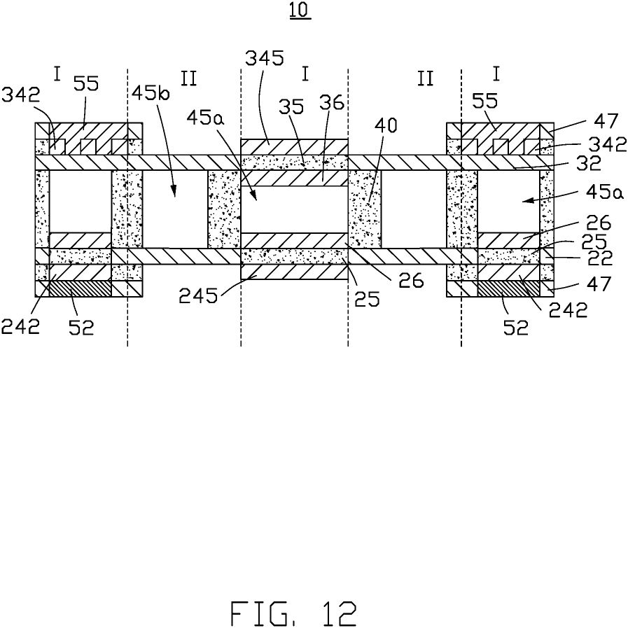

Step S602, referring to FIG. 12, monitoring elements 55 are connected to the fuses 342.

The monitoring element 55 is used to monitor a working condition of the battery cell 70 and transmit a monitoring result to a battery management system (BMS) (not shown), so that the battery management system can control the working condition of a battery according to the working condition of the battery cell.

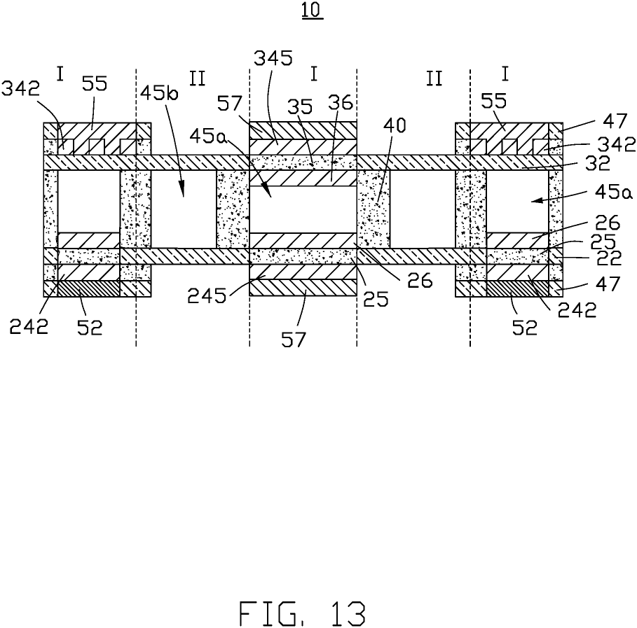

Step S603, referring to FIG. 13, adhesive layers 57 are bonded to surfaces of the first copper block 245 and the second copper block 345.

The adhesive layers 57 can be made of any adhesives, such as curing adhesive.

Step S604, referring to FIG. 14, both ends of the circuit board 10 are bent toward a side where the connecting sheets 52 are located to form the holding groove 60.

The bending areas II are bent, the connecting sheets 52 and the first copper block 245 face and enclose the holding groove 60, and the fuses 342 and the second copper block 345 are on a side of the second dielectric layer 32 facing away from the holding groove 60.

Step S605, referring to FIG. 14, the battery cell 70 is placed in the holding groove 60, and the battery cell 70 is coupled to the circuit board 10 through the connecting sheets 52, thereby forming the battery assembly 100.

The first copper block 245 facing the holding groove 60 is coupled to the battery cell 70 through one adhesive layer 57, so that the battery cell 70 is fixed in the holding groove 60. The second copper block 345 facing away from the holding groove 60 is coupled to another one battery cell 70 to transfer heat away from the battery cell 70. The arrangement of the first copper block 245 and the second copper block 345 increase a contact area between the battery cell 70 and the circuit board, thereby improving the heat dissipation performance.

Referring to FIG. 14, the battery assembly 100 is illustrated. The battery assembly 100 includes at least one circuit board 10 and at least one battery cell 70. The circuit board 10 defines a holding groove 60, the battery cell 70 is accommodated in the holding groove 60 and is electrically connected to the circuit board 10. The battery cell 70 includes a positive tab (not shown) and a negative tab (not shown) which are electrically coupled to the circuit board 10.

The circuit board 10 includes the heat dissipation areas I and the bending areas II which are connected in turn and are alternately arranged. The heat dissipation areas I and the bending areas II enclose the holding groove 60, and the bending areas II correspond in position to corner areas of the battery cell 70.

The circuit board 10 includes the first dielectric layer 22, the second dielectric layer 32, the adhesive film 40, the fuses 342, the bus bars 242, the first copper block 245, and the second copper block 345.

The first dielectric layer 22 and the second dielectric layer 32 are made of a flexible material selected from a group consisting of polyimide, liquid crystal polymer, modified polyimide, and any combination thereof.

The adhesive film 40 is located between the first dielectric layer 22 and the second dielectric layer 32. The adhesive film 40 is bonded to and supports the first dielectric layer 22 and the second dielectric layer 32, so that the cavities 45a are formed between the first dielectric layer 22 and the second dielectric layer 32.

The cavities 45a are at least located in the heat dissipation areas I, and the cavities 45a are filled with air. Since the heat dissipation performance of air is better than that of the first dielectric layer 22 and the second dielectric layer 32, the arrangement of the cavities 45a can improve the heat dissipation performance and reduce a weight of the battery assembly 100. In some embodiments, the cavities 45a can also be filled with liquid, such as water, to further improve the heat dissipation efficiency.

In some embodiments, the cavities 45b are formed between the first dielectric layer 22 and the second dielectric layer 32 in the bending areas II, which is convenient for bending in the process of forming the battery assembly 100.

In some embodiments, the number of cavities 45a or 45b located in one heat dissipation area I or one bending area II is not limited to one, but can also be multiple, and multiple cavities 45a or 45b are spaced through the adhesive film 40.

The bus bars 242 and the first copper block 245 are located on the surface of the first dielectric layer 22 facing away from the second dielectric layer 32, and the fuses 342 and the second copper block 345 are located on the surface of the second dielectric layer 32 facing away from the first dielectric layer 22. The fuses 342, the bus bars 242, the first copper block 245, and the second copper block 345 are all located in the heat dissipation areas I.

The bus bars 242 correspond in position to the positive tab and the negative tab of the battery cell 70, so as to facilitate the electrical connection between the circuit board 10 and the battery cell 70.

In some embodiments, the battery assembly 100 further includes the connecting sheets 52. The connecting sheets 52 are located on surfaces of the bus bars 242 facing the battery cell 70 and electrically connect the bus bars 242 and the battery cell 70.

The fuses 342 are on a surface of the second dielectric layer 32 facing away from the bus bars 242. In the same area, the position of the fuse 342 corresponds to the position of the busbar 242.

The second thermally conductive sheet 36 is not disposed on the surface of the second dielectric layer 32 facing away from the fuses 342 in the heat dissipation area I, which can prevent the heat from transferring to the fuses 342 and causing the fuses 342 to overheat.

The first block copper 245 is connected to a surface of the battery cell 70, so that heat from the battery cell 70 can be transferred quickly. In some embodiments, the adhesive layer 57 is disposed between the first copper block 245 and the battery cell 70. The adhesive layer 57 connects the first copper block 245 and the battery cell 70. The adhesive layer 57 is elastic and can play a buffering role.

The second copper block 345 is located on a surface of the second dielectric layer 32 facing away from the battery cell 70. The heat generated by the battery cell 70 is transferred through the first copper block 245, the cavities 45, and the second copper block 345. The second copper block 345 is coupled to a surface of another one battery cell 70 to transfer heat away from the battery cell 70.

The first copper block 245 and the first thermally conductive sheet 26 can be bonded by the first thermally conductive adhesive 25. The second copper block 345 and the second thermally conductive sheet 36 can be bonded by the second thermally conductive adhesive 35.

In some embodiment, the battery assembly 100 further includes the first thermally conductive sheet 26 and the second thermally conductive sheet 36. The first thermally conductive sheet 26 is located a surface of the first dielectric layer 22 facing the cavity 45a. The second thermally conductive sheet 36 is located on a surface of the second dielectric layer 32 facing the cavity 45a.

Thickness of the first thermally conductive sheet 26 and the second thermally conductive sheet 36 are 25 µm to 50 µm, so that the cavities 45a and 45b can have a certain flexibility and the circuit board 10 can be bent during the manufacturing process.

In some embodiments, the battery assembly 100 further includes monitoring elements 55. The monitoring elements 55 and the fuses 342 are on the same surface of the second dielectric layer 32, the monitoring elements 55 are coupled to the fuses 342.

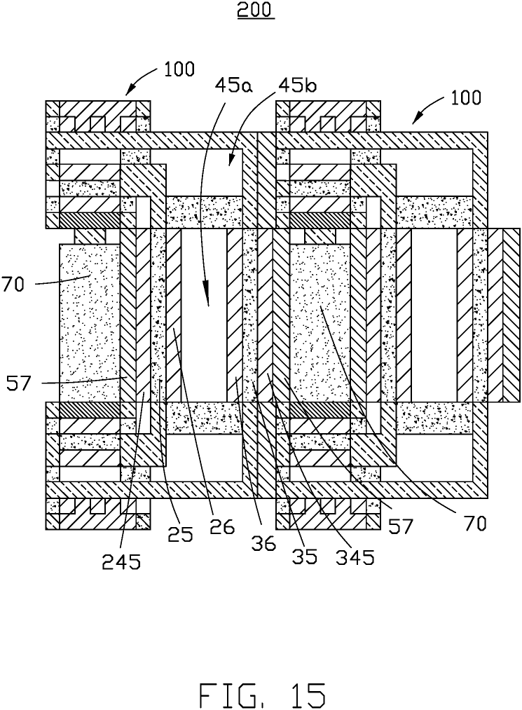

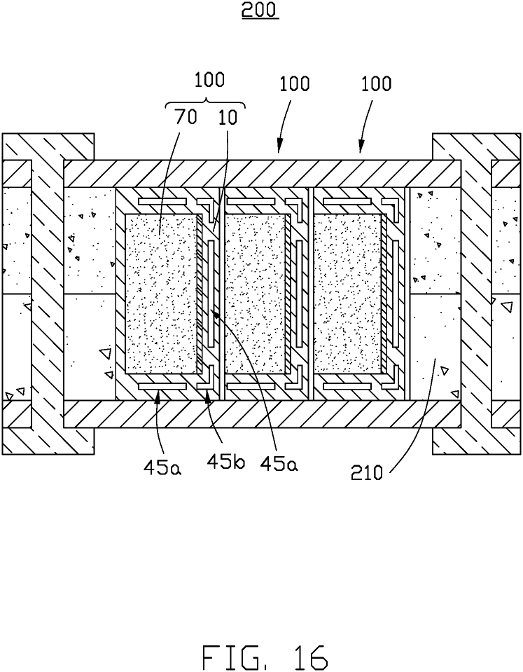

Referring to FIGS. 15 and 16, a battery module 200 according to an embodiment is illustrated. The battery module 200 includes at least two battery assemblies 100, two adjacent battery cells 70 are spaced through the circuit board 10. The second copper block 345 of one battery assembly 100 is connected with a surface of the battery cell 70 of another battery assembly 100 of the two adjacent battery assemblies 100.

In some embodiments, the battery module 200 further includes a bracket 210 for fixing the battery assembly 100.

The busbars 242, fuses 342, and other components are all arranged on the same circuit board 10, which can save the space required for additional busbar and fuse 342. The battery cell 70 is surrounded by the circuit board 10 from different directions, so that heat generated by the battery cell 70 can be transferred quickly. Moreover, the arrangement of the first copper block, the second copper block, and the cavities 45a in the circuit board 10 further improves the heat dissipation efficiency of the circuit board 10, ensuring the working condition of the battery assembly 100.

While the present disclosure has been described with reference to particular embodiments, the description is illustrative of the disclosure and is not to be construed as limiting the disclosure. Therefore, those of ordinary skill in the art can make various modifications to the embodiments without departing from the scope of the disclosure as defined by the appended claims.

What is claimed is:

1. A battery assembly comprising:
a battery cell; and
a circuit board, the circuit board comprising:
a first dielectric layer,
a second dielectric layer,
an adhesive film located between the first dielectric layer and the second dielectric layer and comprising a plurality of cavities spaced from each other;
a bus bar located on a surface of the first dielectric layer facing away from the second dielectric layer,
a first copper block located on the surface of the first dielectric layer facing away from the second dielectric layer, and
a fuse located on a surface of the second dielectric layer facing away from the first dielectric layer, and
a second copper block located on the surface of the second dielectric layer facing away from the first dielectric layer;
wherein the circuit board is divided into a plurality of heat dissipation areas and a plurality of bending areas which are connected in turn and are alternately arranged, the plurality of heat dissipation areas and the plurality of bending areas enclose a holding groove; the bus bar, the first copper block, the fuse, and the second copper block are arranged on the plurality of heat dissipation areas, the bus bar and the first block copper are accommodated in the holding groove, the battery cell is accommodated in the holding groove and is electrically coupled to the circuit board through the bus bar.

2. The battery assembly of claim 1, further comprising a first thermally conductive sheet and a second thermally conductive sheet, wherein the first thermally conductive sheet is arranged on a surface of the first dielectric layer facing the plurality of cavities, the second thermally conductive sheet is arranged on a surface of the second dielectric layer facing the plurality of cavities.

3. The battery assembly of claim 2, further comprising a first thermally conductive adhesive and a second thermally conductive adhesive, wherein the first thermally conductive adhesive is sandwiched between the first copper block and the first thermally conductive sheet, the second thermally conductive adhesive is sandwiched between the second copper block and the second thermally conductive sheet.

4. The battery assembly of claim 1, wherein the first copper block is coupled to the battery cell through an adhesive layer.

5. The battery assembly of claim 1, further comprising a monitoring element coupled to the fuse.

6. The battery assembly of claim 1, further comprising a connecting sheet connecting the bus bar and the battery cell.

7. The battery assembly of claim 1, wherein the plurality of cavities are filled with liquid.

8. A battery module comprising:
at least two battery assemblies, each of the at least two battery assemblies comprising:
a battery cell; and
a circuit board, the circuit board comprising:
a first dielectric layer,
a second dielectric layer,
an adhesive film located between the first dielectric layer and the second dielectric layer and comprising a plurality of cavities spaced from each other;
a bus bar located on a surface of the first dielectric layer facing away from the second dielectric layer,
a first copper block located on the surface of the first dielectric layer facing away from the second dielectric layer, and
a fuse located on a surface of the second dielectric layer facing away from the first dielectric layer, and
a second copper block located on the surface of the second dielectric layer facing away from the first dielectric layer;
wherein the circuit board is divided into a plurality of heat dissipation areas and a plurality of bending areas which are connected in turn and are alternately arranged, the plurality of heat dissipation areas and the plurality of bending areas enclose a holding groove; the bus bar, the first copper block, the fuse, and the second copper block are arranged on the plurality of heat dissipation areas, the bus bar and the first block copper are accommodated in the holding groove, the battery cell is accommodated in the holding groove and is electrically coupled to the circuit board through the bus bar;
the second copper block of one of the at least two battery assemblies is coupled to the battery cell of another battery assembly of two adjacent battery assemblies.

9. The battery module of claim 8, wherein each of the at least two battery assemblies further comprises a first thermally conductive sheet and a second thermally conductive sheet, the first thermally conductive sheet is arranged on a surface of the first dielectric layer facing the plurality of cavities, the second thermally conductive sheet is arranged on a surface of the second dielectric layer facing the plurality of cavities.

10. The battery module of claim 9, wherein each of the at least two battery assemblies further comprises a first thermally conductive adhesive and a second thermally conductive adhesive, wherein the first thermally conductive adhesive is sandwiched between the first copper block and the first thermally conductive sheet, the second thermally conductive adhesive is sandwiched between the second copper block and the second thermally conductive sheet.

11. The battery assembly of claim 8, wherein in each of the at least two battery assemblies, the first copper block is coupled to the battery cell through an adhesive layer.

12. The battery module of claim 8, wherein each of the at least two battery assemblies further comprises a monitoring element coupled to the fuse.

13. The battery module of claim 8, wherein each of the at least two battery assemblies further comprises a connecting sheet connecting the bus bar and the battery cell.

14. The battery module of claim 8, wherein the plurality of cavities are filled with liquid.

15. A method for manufacturing a battery assembly, comprising:
providing a first substrate, the first substrate comprising a first copper layer, a first dielectric layer, and a plurality of first thermally conductive adhesives, the first dielectric layer being on a surface of the first copper layer, the plurality of first thermally conductive adhesives penetrating the first dielectric layer and being coupled to the first copper layer;
providing a second substrate, the second substrate comprising a second copper layer, a second dielectric layer, and at least one second thermally conductive adhesive, the second dielectric layer being on a surface of the second copper layer, the at least one second thermally conductive adhesive penetrating the second dielectric layer and being coupled to the second copper layer;
providing an adhesive film, the adhesive film comprising a plurality of through holes which correspond in position to the plurality of first thermally conductive adhesives;
pressing the first substrate and the second substrate onto both sides of the adhesive film to seal the plurality of through holes to form a plurality of cavities, thereby forming a plurality of heat dissipation areas and a plurality of bending areas which are alternately arranged;
etching the first copper layer to form a bus bar and a first copper block, and etching the second copper layer to form a fuse and a second copper block, thereby forming a circuit board; and
bending the plurality of bending areas of the circuit board to form a holding groove, placing a battery cell in the holding groove, and connecting the battery cell to the bus bar, thereby forming the battery assembly.

16. The method of claim 15, wherein providing a first substrate comprises:
providing a single-sided copper clad laminate, the single-sided copper clad laminate comprising the first dielectric layer and the first copper layer on the first dielectric layer;
removing portions of the first dielectric layer to form a plurality of grooves which expose a surface of the first copper layer; and
infilling the plurality of grooves with the plurality of first thermally conductive adhesives.

17. The method of claim 16, further comprising attaching a plurality of first thermally conductive sheets onto surfaces of the plurality of the first thermally conductive adhesives to form the first substrate.

18. The method of claim 17, further comprising attaching at least one second thermally conductive sheet on a surface of the at least one second thermally conductive adhesive to form the second substrate, wherein the at least one second thermally conductive sheet corresponds in position at least one of the plurality of first thermally conductive sheets.

19. The method of claim 15, further comprising connecting a connecting sheet to a surface of the bus bar, wherein the battery cell is coupled to the battery cell through the connecting sheet.

20. The method of claim 15, further comprising forming an adhesive layer on a surface of the first copper block, wherein the first copper block is accommodated in the holding groove and is coupled to the battery cell through the adhesive layer.
